(19) United States
(12) Patent Application Publication
(10) Pub. No.: US 2005/0183970 A1
(43) Pub. Date: Aug. 25, 2005

(54) Charze painting palette

(76) Inventor: Joseph C. Lalino, Concord, NC (US)

Correspondence Address: Mr. Joseph C. Lalino, 118 Poplar Woods Dr., Concord, NC, 28027, US

(21) Appl. No.: 10/780,687

(22) Filed: Feb. 19, 2004

(51) Int. Cl. B44D 3/00

(52) U.S. Cl. 206/1.8

(57) ABSTRACT

The invention (known as “The Charze Painting Palette” at this time) is a new form of palette artists can use to enhance the process of painting. The initial model is set to have one upper holding tray (primarily used for holding “white” paint): a second tier with 6 “wells”: a third tier with 6 more “wells”: a lower tier with two mixing bays on it and lastly a wiping blade to aid in discarding unwanted paint on the artist's brush. Please note that the patent (once granted) should cover the conceptual and intellectual property as it pertains to the frontal design of my palette (meaning that mine is the first ever to incorporate the sloping style of holding paints on a multi-level palette with the unique holding mechanism I designed). Though the design can change of how “the wells” are situated and so forth I would like my patent to assure me that anyone trying to copy or make a palette that resembles mine (with similarities in the frontal design or in the handle mechanism design) should be prohibited from doing so.

### FIELD OF THE INVENTION

The present invention relates to managing artists paints while painting and more particularly to a palette for managing paints.

### BACKGROUND OF THE INVENTION

Most artist use some type of palette when painting. Up to now artists have had few choices available to them where painting palettes are concerned. Most of the palettes currently available require the artist to use his or her thumb to steady or hold the palette while working with it. What is needed is a palette that artists can enjoy working with that frees up their thumb yet gives them total control of the palette while they are painting with it.

There are no solutions that I know of at the present time that allow artists to hold their palettes in an advantageous way. Not one company offers a palette with a handle construction and frontal design that permits freedom of the artist's thumb while using the palette.

The shortcomings of traditional palettes lie in how the palettes must be held and the pressure that must be exerted on the thumb while holding the palette in place and in a “workable” position.

It is therefore an object of the invention to give artists a new alternative where palettes are concerned whereby they can enjoy a more comfortable, easy-to-use and less cumbersome palette.

It is another object of the invention to give artists more freedom of movement while painting, freeing them from the task of carrying around big bulky wooden palettes of yesteryear.

It is another object of the invention to free up the artist's thumb by not requiring it to play a part in holding the palette, so that it can remain in its natural position.

### SUMMARY OF THE INVENTION

In accordance with the present invention, there is provided a four-tier hand-held palette. The upper tier is a tray for containing a single paint color. The next tier has six compartments or “wells” for individual paint colors. Below this is another tier of six more compartments for six paint colors and lastly the bottom tier is used for mixing colors together right on the palette.

My palette is unlike others in the respect of how it is held. My design allows the artist to “wear” the palette instead of having to “hold” it. My unique handle design allows the palette to rest on the hand rather than having to burden the thumb with constant pressure to keep the palette in place or from falling off the hand.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front prespective view of a my palette showing the invention as it would look if seen from “head on”.

FIG. 2 is a front perspective view of a the palette: (one dimensional rendering).

FIG. 3 is a side perspective view of a the palette.

FIG. 4 is a side perspective view of a the palette from a 45 degree side angle.

FIG. 5 is a top-down perspective view of a my palette if seen from overhead.

FIG. 6 is a rear perspective view of a the palette showing the handle assembly where the thumb would be placed.

FIG. 7 is a rear perspective view of a the handle assembly as if it were transparent.

FIG. 8 is a rear perspective view of a the handle assembly if it were solid and not transparent.

FIG. 9 is a rear perspective view of a “Charze Painting Palette” showing a full shot of the handle assembly and where it appears on the palette.

For purposes of clarity and brevity, like elements and components will bear the same designations and numbering throughout the FIGURES.

### DESCRIPTION OF THE PREFERRED EMBODIMENT

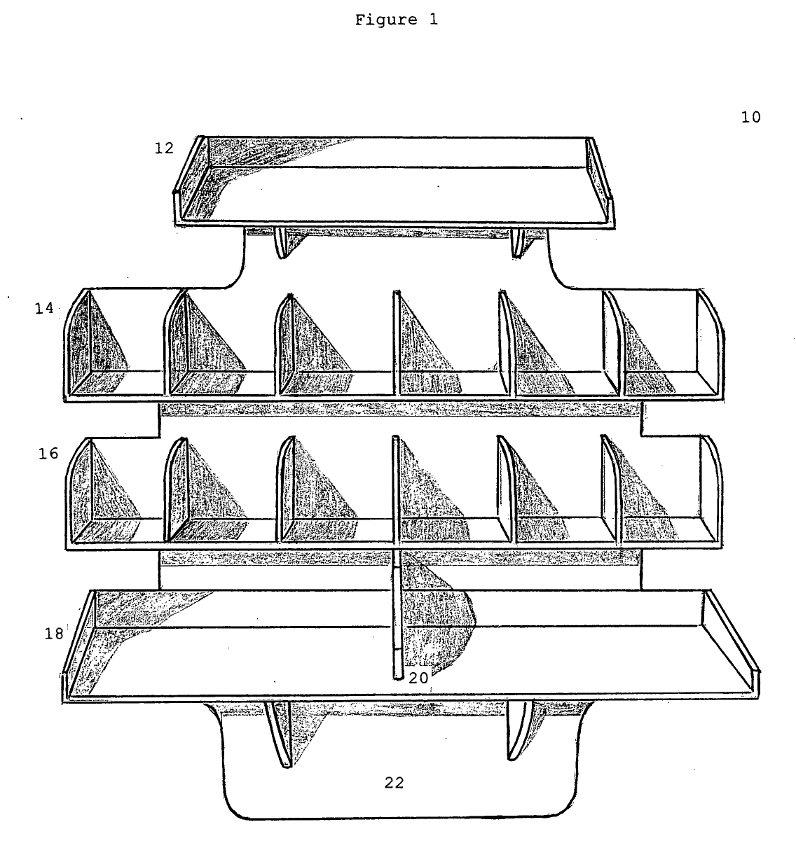

FIG. 1 is a front perspective view of my palette: (reference numeral 10). In the diagram on the upper tier you will see the top holding tray (reference numeral 12) On the next lower tier you will see the first set of 6 “wells” on the palette used for storing and holding paint: (reference numeral 14). The tier below this one contains the second set of 6 “wells”: (reference numeral 16). And lastly the bottom tier is a tray (reference numeral 18) used for mixing paint colors that also contains a wiping blade built into it: (reference numeral 20). The main support body portion of the palette can be seen in the lower part of the diagram: (reference numeral 22). Let it be noted that the palette shows a total of 12 “wells” however future models may be made with fewer or more “wells” in different positions without departing from the scope of the invention likewise future versions may have fewer or more mixing and holding trays in different positions.

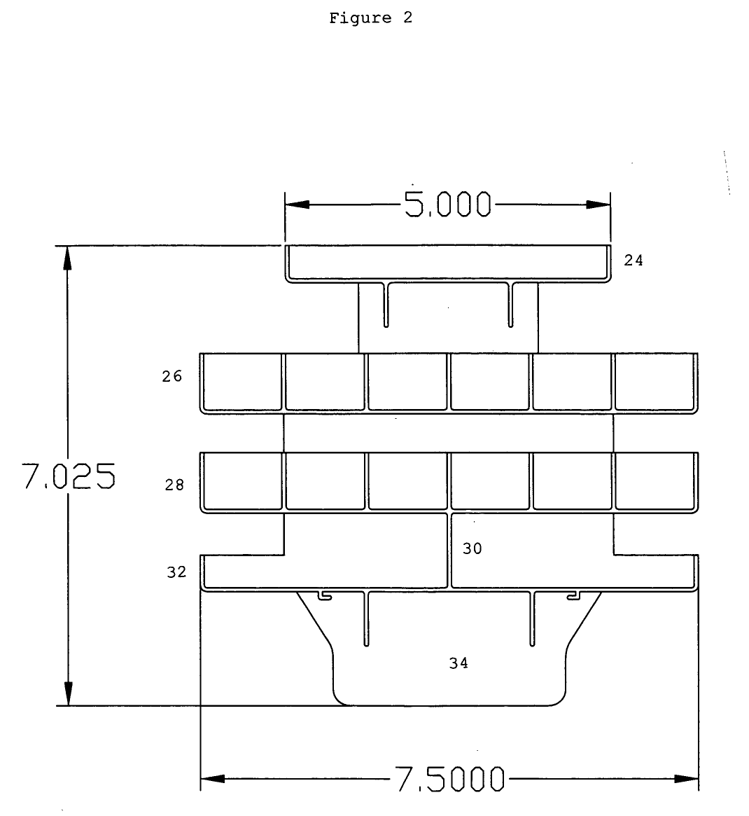

FIG. 2 is another front perspective view of a my palette. In the diagram you will see the top holding tray (reference numeral 24) On the next lower tier you will see the first set of 6 “wells on the palette (reference numeral 26). The tier below this one contains the second set of 6 “wells” (reference numeral 28). The diagram also shows the wiping blade: (reference numeral 30) and the lower tier mixing tray: (reference numeral 32). You can see the main body assembly by looking at reference numeral 34.

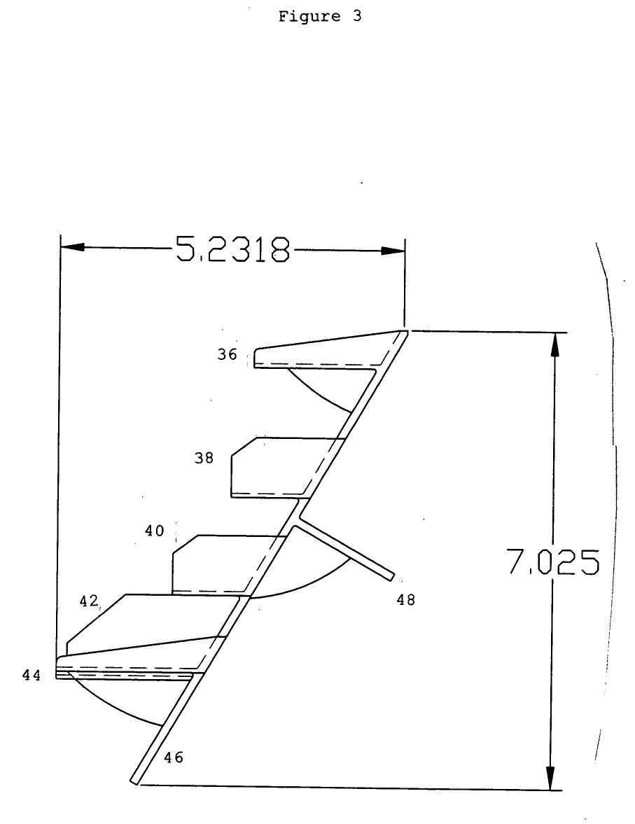

FIG. 3 is a side perpective view of my palette. In the diagram you will see the top holding tray (reference numeral 36). On the next lower tier you will see the first set of 6 “wells”.” on the palette (reference numeral 38). The tier below this one contains the second set of 6 “wells” (reference numeral 40). The diagram also shows the wiping blade: (reference numeral 42) and the lower tier mixing tray (reference numeral 44). From the side you can see the main body assembly (reference numeral 46): and the handle assembly (reference numeral 48).

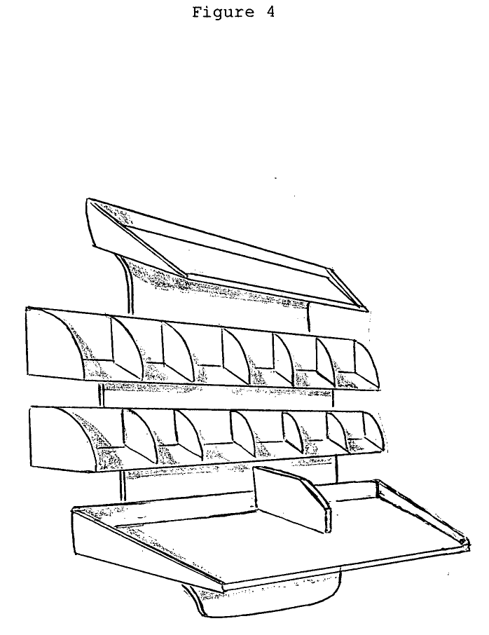

FIG. 4 is a side angle perspective view of my palette.

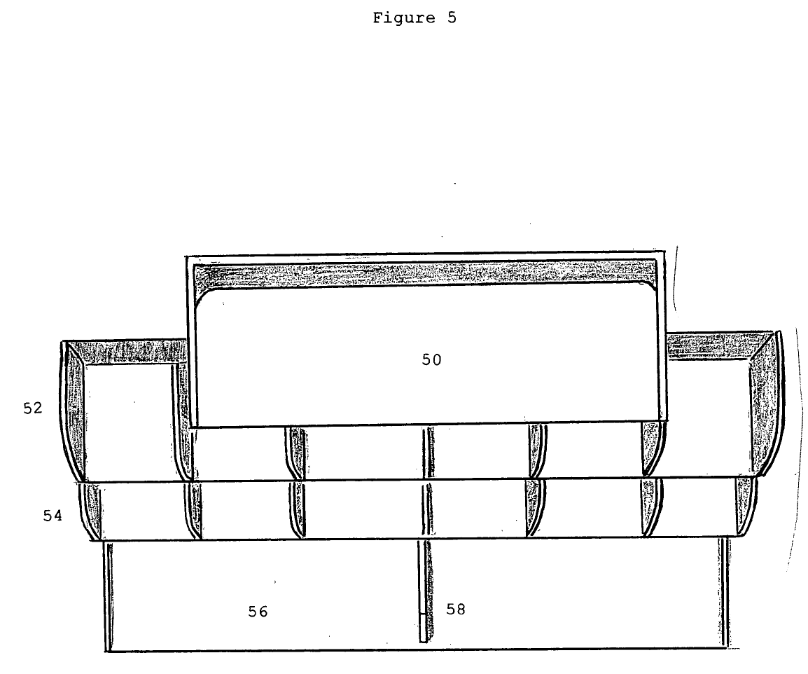

FIG. 5 is a top-down perpective view of my palette. In the diagram you will see the top holding tray (reference numeral 50). On the next lower tier you will see the first set of 6 “wells” on the palette (reference numeral 52). The tier below this one contains the second set of 6 “wells” (reference numeral 54). You will see the lower tier mixing tray: (reference numeral 56) and the wiping blade (reference numeral 58).

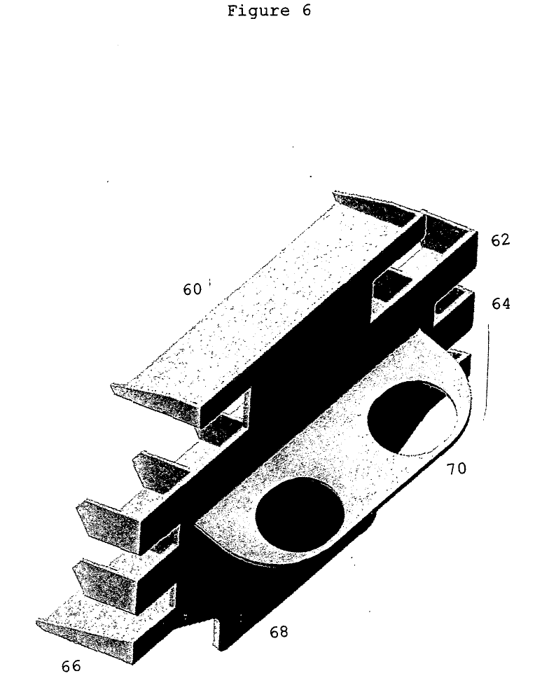

FIG. 6 is a rear perspective view of my palette. In the diagram you will see the top holding tray (reference numeral 60). On the next lower tier you will see the first set of 6 “wells” on the palette (reference numeral 62). The tier below this one contains the second set of 6 “wells” (reference numeral 64). The diagram also shows the lower mixing tray: (reference number 66) and the main body assembly (reference numberal 68) as well as the handle mechanism: (reference numeral 70).

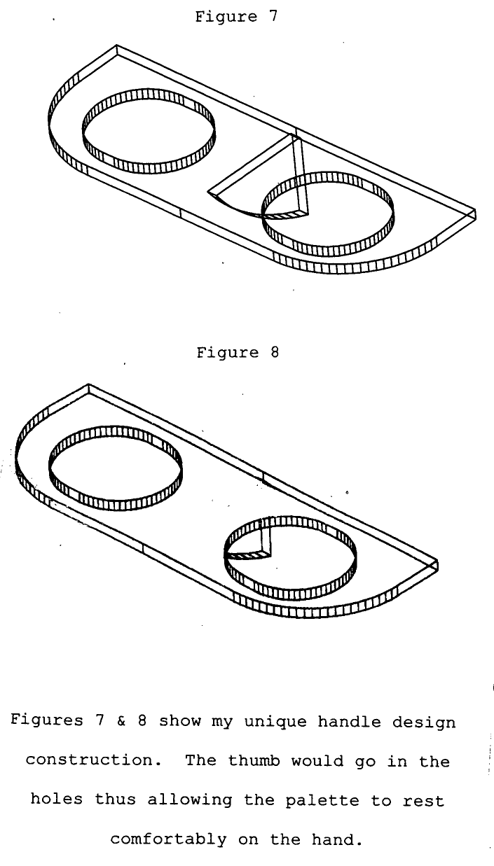

FIG. 7 is a close-up perspective of the handle mechanism design as if transparent. Let is be noted that the handle mechanism is the most important part of the patent with it's unique design.

FIG. 8 is a close-up perspective of the handle mechanism design as if made of solid non-transparent material.

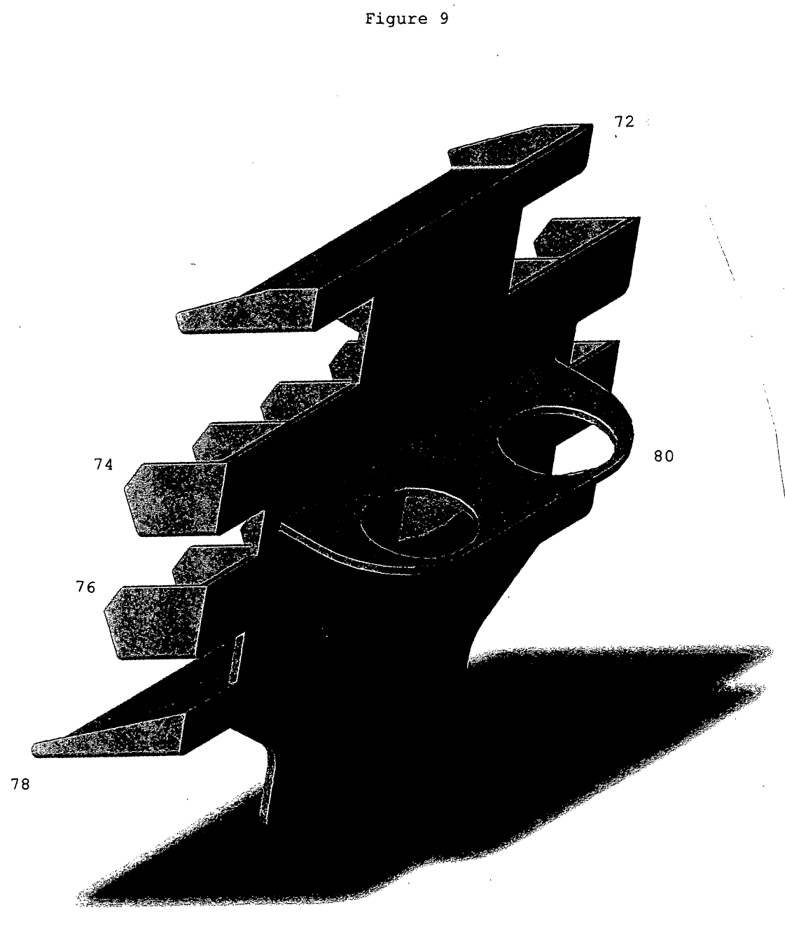

FIG. 9 is a rear perpective view of my palette. In the diagram you will see the top holding tray (reference numeral 72). On the next lower tier you will see the first set of 6 “wells” on the palette (reference numeral 74). The tier below this one contains the second set of 6 “wells” (reference numeral 76). The diagram also shows the lower tier mixing tray: (reference numeral 78) and the handle assembly (reference numeral 80).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A charze painting palette for making it easier for artists to work with thier paints when painting. comprising:
means for storing the paints while the artist is painting;
means for mixing paints on;
means for holding the color “white” or whatever color the artist uses the most;
means for discarding excess paint from the artist's brush; and
means for holding the palette in a way that is “ergonomically correct” and in accordance with how the human hand is made.

2. The charze painting palette in accordance with claim 1, wherein said means for storing the paints while the artist is painting. comprises a “wells”

3. The charze painting palette in accordance with claim 1, wherein said means for mixing paints on. comprises a mixing tray.

4. The charze painting palette in accordance with claim 1, wherein said means for holding the color “white” or whatever color the artist uses the most. comprises an upper tray.

5. The charze painting palette in accordance with claim 1, wherein said means for discarding excess paint from the artist's brush. comprises a wiping blade.

6. The charze painting palette in accordance with claim 1, wherein said means for holding the palette in a way that is “ergonomically correct” and in accordance with how the human hand is made. comprises a specially-designed handle.

7. A charze painting palette for making it easier for artists to work with their paints when painting. comprising:
a wells, for storing the paints while the artist is painting;
a mixing tray, for mixing paints on;
an upper tray, for holding the color “white” or whatever color the artist uses the most;
a wiping blade, for discarding excess paint from the artist's brush; and
a specially-designed handle, for holding the palette in a way that is “ergonomically correct” and in accordance with how the human hand is made.

8. A charze painting palette for making it easier for artists to work with their paints when painting. comprising:
a wells, for storing the paints while the artist is painting;
a mixing tray, for mixing paints on;
an upper tray, for holding the color “white” or whatever color the artist uses the most;
a wiping blade, for discarding excess paint from the artist's brush; and
a specially-designed handle, for holding the palette in a way that is “ergonomically correct” and in accordance with how the human hand is made.
